(19) United States
(12) Patent Application Publication
(10) Pub. No.: US 2016/0334526 A1
(43) Pub. Date: Nov. 17, 2016

(54) METHOD AND APPARATUS FOR MODELING AND SEPARATION OF PRIMARIES AND INTERNAL MULTIPLES USING SOLUTIONS OF THE TWO-WAY WAVE EQUATION

(71) Applicant: CGG SERVICES SA, Massy Cedex (FR)

(72) Inventor: Antonio PICA, Vanves (FR)

(73) Assignee: CGG SERVICES SA, Massy Cedex (FR)

(21) Appl. No.: 15/109,689

(22) PCT Filed: Jan. 12, 2015
(86) PCT No.: PCT/IB15/00156

§ 371 Date: Jul. 5, 2016

Related U.S. Application Data
(60) Provisional application No. 61/926,677, filed on Jan. 13, 2014.

(51) Int. Cl. G01V 1/28; G01V 1/36

(52) U.S. Cl. CPC G01V 1/282; G01V 1/362; G01V 2210/671

(57) ABSTRACT

Method and apparatus for seismic data processing estimate primaries and/or internal multiples by solving a two-way wave equation using first and later arrivals from each layer of an underground formation explored using waves, and summing contributions of the layers to the primaries and/or the internal multiples, without using adaptive subtraction.

### CROSS REFERENCE TO RELATED APPLICATIONS

This application claims priority and benefit from U.S. Provisional Patent Application No. 61/926,677, filed Jan. 13, 2014, for “Modeling and Separation of Primaries and Internal Multiple Reflections from Solutions of the Two-way Wave Equation,” the entire content of which is incorporated in its entirety herein by reference.

### BACKGROUND

1. Technical Field

Embodiments of the subject matter disclosed herein generally relate to processing seismic data using a subsurface model. More specific, primaries and internal multiple reflections are modeled and separated based on solutions of the two-wave equation.

2. Discussion of the Background

Hydrocarbon exploration and development uses waves (e.g., seismic waves or electromagnetic waves) to explore the structure of underground formations on land and at sea (i.e., formations under the seafloor). As schematically illustrated in FIG. 1, waves emitted by a source 110 at a known location penetrate an explored formation 120 and are reflected at interfaces 122, 124, 126 that separate the formation's layers having different layer impedances. Sensors 130 detect the reflected waves. The detected waves include primaries such as 140 traveling directly from a formation interface to a sensor, and internal multiple reflections such as 150, which are reflected at least a few more times inside the formation before being detected. In order to understand the structure of the explored underground formation, it is preferable that primaries and internal multiple reflections be separated.

Analyzing internal multiples has been performed using Vertical Seismic Profile (VSP) techniques which employ measuring seismic properties using sources or sensors placed along depth (e.g., in a well drilled through the explored formation). Conventional methods try to separate up-going and down-going waves to then examine the internal multiple reflections. Note that “internal multiple reflections” and “internal multiples” are interchangeable used in this document. The accuracy of the conventional methods is limited by the lack of effective separation.

Some conventional methods use the two-way wave equation by adjusting the impedances (as described in “Predicting multiples using a reverse time demigration” by Zhang and Duan, SEG Las Vegas 2012, SEG Technical Program Expanded Abstracts, 1-5, which is incorporated herein by reference) or by canceling up-going paths when using matrix propagation (as described in “Seismic Wave Propagation in Stratified Media” by B. Kennett, Cambridge University Press, 1983, which is incorporated herein by reference). The solutions obtained using such methods are altered with respect to the two-way wave equation. In fact (as discussed in “Seismic Interpretation, The Physical Aspects” by N. A. Antsley, Prentice Hall, 1977, which is incorporated herein by reference), down-going waves include not only already-detected internal reflections, but also other micro-period (due to waves bouncing plural times within a layer) internal multiple reflections.

Conventional methods for modeling internal multiples do not take into consideration all the internal multiples (e.g., ignoring the micro-period ones), which recently has been proven necessary (as argued in “Integrated migration and internal multiple elimination” by Wapenaar et al., SEG Las Vegas 2012, SEG Technical Program Expanded Abstracts, 1-5, which is incorporated herein by reference).

Thus, conventional methods have used incomplete or inaccurate approaches to model and separate primaries and internal multiple reflections. In the context of increasing computing power, it is momentous to develop accurate and complete methods for modeling primaries and internal reflections using the acquired data as guidance.

### SUMMARY

In some embodiments, the two-way wave equation is solved to model and separate primaries and internal multiple reflections. The two-way wave equation is defined using a layer model of the explored formation obtained from log data or by inversion. Solving the two-way wave equation uses the first and the later arrivals corresponding to a layer interface, the arrivals being extracted from the data. Using a layer model based on actual data with the full two-wave equation without using adaptive subtraction yields a very realistic internal multiples model.

According to one embodiment, there is a method for processing data recorded by sensors while exploring an underground formation using waves. The method includes receiving the data, and obtaining a layer model that specifies one or more impedance and/or velocity changes inside the underground formation. A layer of the model layer is defined between adjacent among the one or more impedance and/or velocity changes. The method further includes extracting from the data, first and later arrivals of the waves emerging from each of the one or more impedance and/or velocity changes. The method then includes estimating at least one of primaries and internal multiples by solving a two-way wave equation using the first and the later arrivals for each layer of the model layer, and summing portions of resulting solutions to obtain the primaries and/or to the internal multiples.

According to another embodiment, there is a data processing apparatus having an interface and a data processing unit. The interface is configured to receive log data and data recorded by sensors while exploring an underground formation, using waves. The data processing unit is configured to obtain a layer model from the log data, the layer model specifying one or more impedance changes inside the underground formation. A layer of the model layer is defined between adjacent among the one or more impedance and/or velocity changes. The data processing unit is further configured to extract from the data, first and later arrivals of the waves emerging from each of the one or more impedance changes. The data processing unit is also configured to estimate at least one of primaries and internal multiples by solving a two-way wave equation using the first and the later arrivals for each layer of the model layer, using the first and later arrivals, and then summing portions of resulting solutions to obtain the primaries and/or to the internal multiples.

According to yet another embodiment, there is a non-transitory computer-readable medium storing executable codes, which, when executed by a computer, make the computer perform a method for processing data recorded by sensors while exploring an underground formation using waves. The method includes obtaining a layer model that specifies one or more impedance and/or velocity changes inside the underground formation. A layer of the model layer is defined between adjacent among the one or more impedance and/or velocity changes. The method further includes extracting from the data, first and later arrivals of the waves emerging from each of the one or more impedance and/or velocity changes. The method then includes estimating at least one of primaries and internal multiples by solving a two-way wave equation using the first and the later arrivals for each layer of the model layer, and summing portions of resulting solutions to obtain the primaries and/or to the internal multiples.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of exploring underground formations using waves;

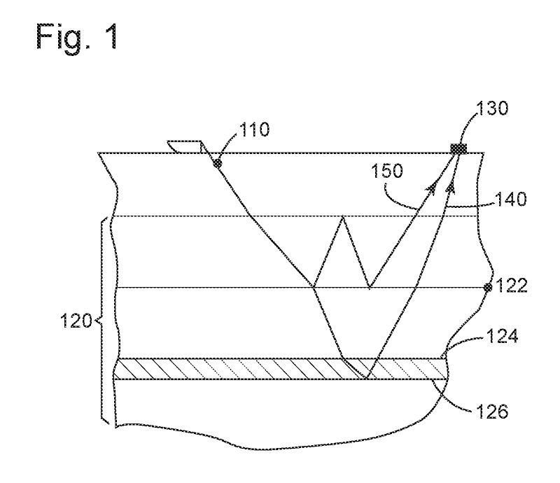

FIG. 2 is a graph of wave propagation velocity versus depth;

FIG. 3 is a graph of density versus depth;

FIG. 4 is a two-dimensional velocity model according to an embodiment;

FIG. 5 illustrates the contribution of a layer to the full solution of the two-wave equation, according to an embodiment;

FIG. 6 illustrates the contribution of a layer to the primary reflections, according to an embodiment;

FIG. 7 illustrates the contribution of a layer to the internal multiple reflections, according to an embodiment;

FIG. 8 illustrates the full solution of the two-wave equation, according to an embodiment;

FIG. 9 illustrates the primary reflections, according to an embodiment;

FIG. 10 illustrates the internal multiple reflections, according to an embodiment;

FIG. 11 is a flowchart of a method according to an embodiment; and

FIG. 12 is a schematic diagram of a data processing apparatus according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed using terminology of seismic data processing. However, the described methods may be used for other wave data processing (e.g., electro-magnetic wave data).

Reference throughout the specification to “one embodiment” or “an embodiment” means that a particular feature, structure or characteristic described in connection with an embodiment is included in at least one embodiment of the subject matter disclosed. Thus, the appearance of phrases “in one embodiment” or “in an embodiment” in various places throughout the specification is not necessarily referring to the same embodiment. Further, the particular features, structures or characteristics may be combined in any suitable manner in one or more embodiments.

In the following various embodiments, the two-way wave equation is set up and solved for layers of an underground formation that have different impedances and propagation velocities for the waves used to explore the formation. The primaries and/or internal multiples are estimated by solving a two-way wave equation using first and later arrivals from layer interfaces without using adaptive subtraction. The first and later arrivals are extracted from the data. The sum of contributions from the selected primaries and the selected internal multiples from every model slices allow to reconstruct ensemble of primary reflections and the ensemble of internal multiple reflections into the full solution of the two way wave equation in a synthetic data modeling exercise. Not using adaptive subtraction provides the advantage of avoiding inaccuracies resulting from adapting the solution to the data.

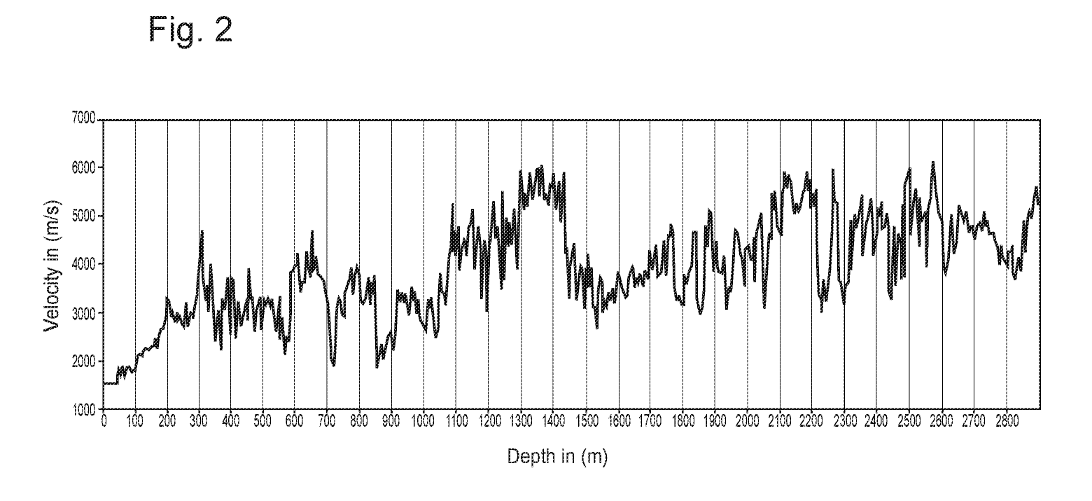

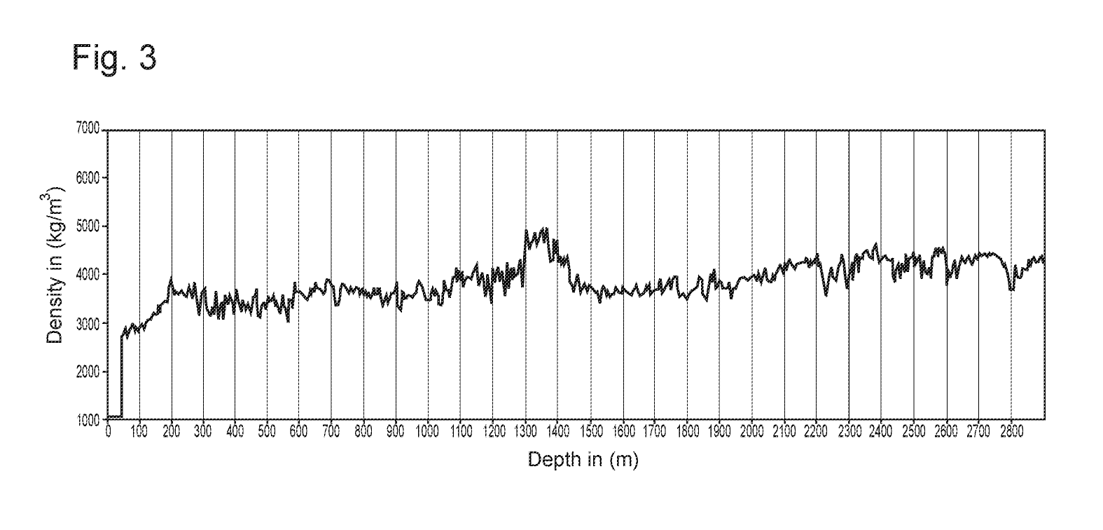

A layer model specifies one or more impedance and wave propagation velocity changes inside the underground formation. The simplest layer model is one-dimensional (i.e., specifying impedance variation with depth), but various embodiments use two-dimensional models and some simpler three-dimensional models. A realistic layer model can be obtained using logs or inversion. For example, FIG. 2 is a graph of wave propagation velocity (in m/s) versus depth (in m), and FIG. 3 is a graph of density (in m/s) versus depth (in m). The log data may be extrapolated by kriging to any time-migrated or depth-migrated section, thus adjusting the velocities and layer thicknesses according to the migrated sections.

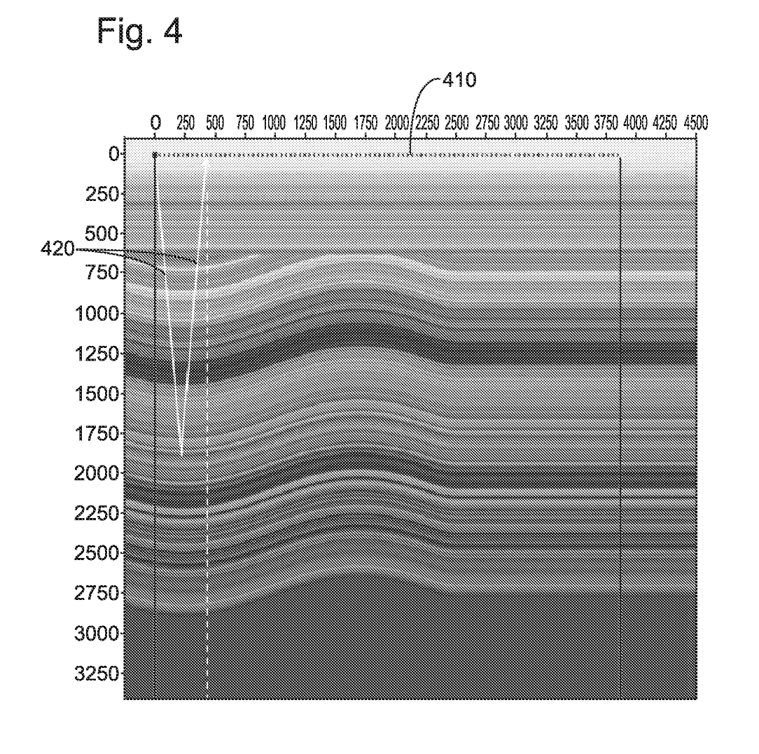

FIG. 4 is a two-dimensional velocity model (the darker the gray hue, the greater the velocity). As previously discussed, this model may be obtained from log data or by inversion. Turning now to the survey data acquisition, a source emits waves at (0,0), the waves detected after traveling through the explored formation by sensors 410 illustrated in FIG. 4 at the formation's surface (i.e., 0 depth). Line 420 illustrates the path of a wave emitted at coordinates (0,0) and reflected at about 1,800 m depth to be detected by a sensor at about 400 m horizontal distance from the location where the wave was emitted. Although the model illustrates substantially parallel layers, this representation is merely an illustration and it is not intended to be limiting.

The first and the later arrivals from a layer between a depth ξ (at which a change of impedance and/or velocity occurs according to the layer model) and a next depth ξ+Δξ (at which a next change of impedance and/or velocity occurs according to the layer model) are extracted from the data. For example, a method for extracting first arrivals is described in “Passive seismic interferometry by multidimensional deconvolution” by Wapenaar et al., published in Geophysics, Vol. 73, No. 6, November-December 2008, pp. A51-A56, which is incorporated herein by reference in its entirety.

The solution of the two-way wave-equation without free surface conditions is R(xs, ys, zs, xg, yg, zg, m), where a wave signal s(t) is emitted from a source location (xs, ys, zs) close to the surface, and the reflected energy (i.e., reflected waves) is recorded at a sensor located at xg, yg, zg (also close to the surface). The two-way wave equation has the general form

$$\frac{1}{{v}^{2}} \frac{{\partial }^{2} R}{\partial {t}^{2}} = Δ R ,$$

where R includes solutions for up-going and down-going waves, and velocity v depends on position according to the layer model. At the source location, the function R is R(xs, ys, zs, t)=s(t).

A layer model m(xm, ym, zm) is used. According to one embodiment, for an investigated depth ξ, the model m(ξ) is:

m(ξ)=m(xm,ym,zm,ξ)=m(xm,ym,zm)·(1−H(z−ξ))+H(z−ξ)·m(xm,ym,ξ) (1)

where H denotes the Heaviside function. With this formula, the model is extended without limit below the investigated depth ξ and has a constant velocity m(xm, ym, ξ) along the z (depth) axis.

In order to discriminate, the primary reflections from the internal multiple reflections resulting from the impedance variations occurring between depth levels ξ and ξ+Δξ (where Δξ is smaller than the spatial wavelength of the currently used wave), the two-way wave equation is solved first for model m(ξ) thus obtaining R(xs, ys, zs, xg, yg, zg, m(ξ)), and then for model m(ξ+Δξ), thus obtaining R(xs, ys, zs, xg, yg, zg, m(ξ+Δξ)). The contribution of the layer between depth levels and ξ+ΔξΔR(ξ) to the full two-way solution is then:

ΔR(ξ)=R(xs,ys,zs,xg,yg,zg,m(ξ+Δξ))−R(xs,ys,zs,xg,yg,zg,m(ξ)). (2)

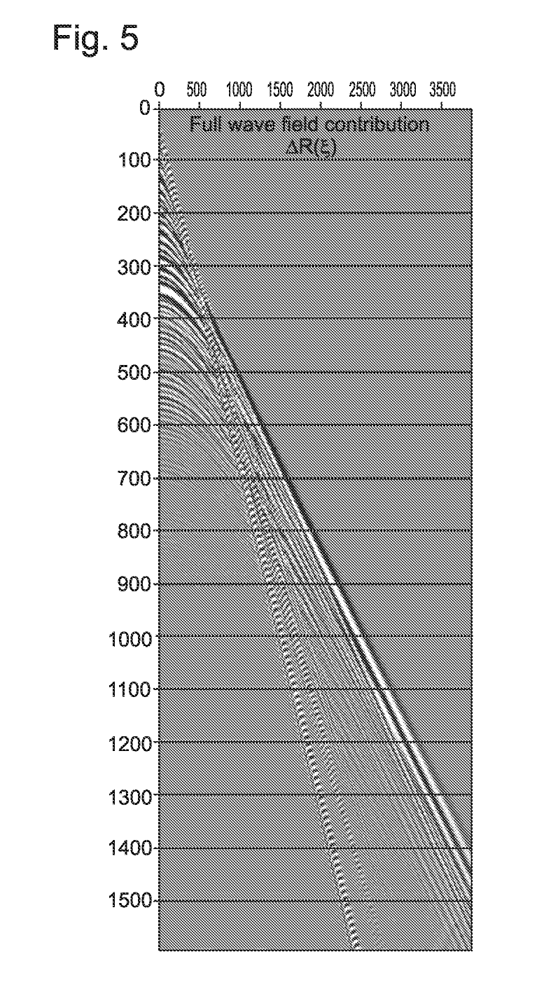

FIG. 5 illustrates the contribution of a layer between depth levels ξ and ξ+Δξ, to the full solution of the two-wave equation. The vertical axis in FIG. 5 is time in ms starting from the moment when a wave is emitted. Various sensors placed on the formation's surface detect reflected waves emerging from the explored formation. The horizontal axis corresponds to the sensors' positions relative to the location where the incident wave is emitted. The gray hues correspond to the positive and negative amplitudes of the detected signals.

By definition, first arrivals (which often have also the highest amplitude) from one interface are due to the primary reflections, and later arrivals are due to internal multiples. An estimation of the two-way travel time of the primary reflections from an impedance change (i.e., interface) located at xm, ym, zm is τ(xg, yg, zg, xm, ym, zm). The contribution to the primary reflections from the layer between depth levels ξ and ξ+Δξ is ΔP(ξ):

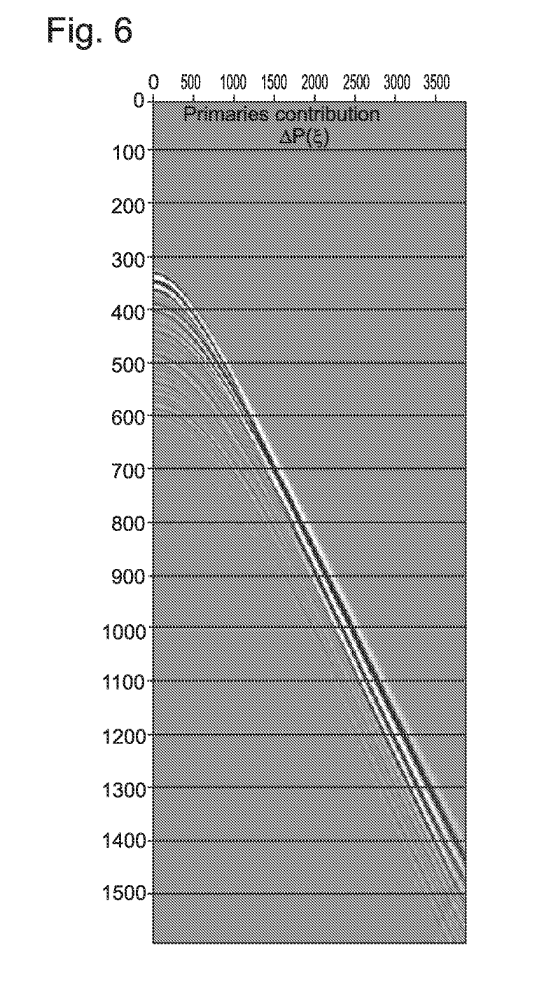

ΔP(ξ)=ΔR(ξ)(1−H(t−(τ(xg,yg,zg,xm,ym,ξ)−T(ξ))), (3)

where τ(xg, yg, zg, xm, ym, ξ) denotes the two-way travel times of the reflections resulting from the layer between depth levels ξ and ξ+Δξ and T(ξ) is the two-way travel times of the reflections to depth ξ. These travel times can be determined analytically in simple models (1D), numerically using ray-tracing techniques, or by using threshold detection given that first arrivals are also the stronger arrivals. FIG. 6 illustrates the contribution of a layer between depth levels ξ and ξ+Δξ, to the primary reflections. The axes and gray hues in FIG. 6 are used in the same manner as in FIG. 5.

The contributions to the internal multiple reflections from the layer between depth levels ξ and ξ+Δξ is ΔM(ξ):

ΔM(ξ)=ΔR(ξ)−ΔP(ξ). (4)

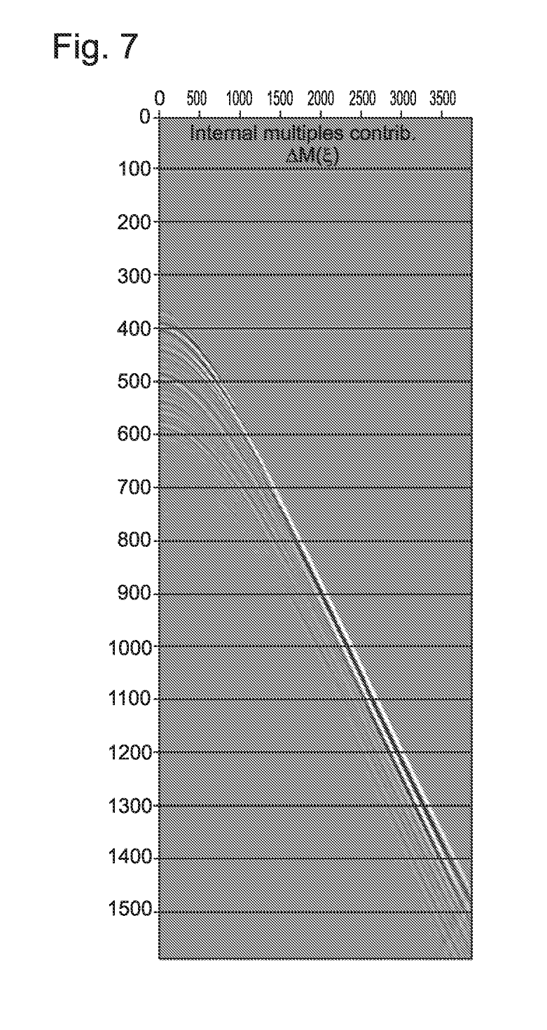

FIG. 7 illustrates the contribution of a layer between depth levels ξ and ξ+Δξ to the internal multiple reflections. The axes and gray hues in FIG. 7 are used in the same manner as in FIGS. 5 and 6.

Contributions of the primaries and the internal multiples from every layer are summed to reconstruct the ensemble of primary reflections and the ensemble of internal multiple reflections in the full solution of the two-way wave equation.

The ensemble of primary reflections P(xs, ys, zs, xg, yg, zg, m) and internal multiple reflections M(xs, ys, zs, xg, yg, zg, m) among the full two-way wave equation solution R(xs, ys, zs, xg, yg, zg, m) are obtained by adding all layers' contributions:

P(xs,ys,zs,xg,yg,zg,m)=Σ_{ξ=ξmax}^{ξ=0}ΔP(ξ)Δξ (5)

and

M(xs,ys,zs,xg,yg,zg,m)=Σ_{ξ=ξmax}^{ξ=0}ΔM(ξ)Δξ. (6)

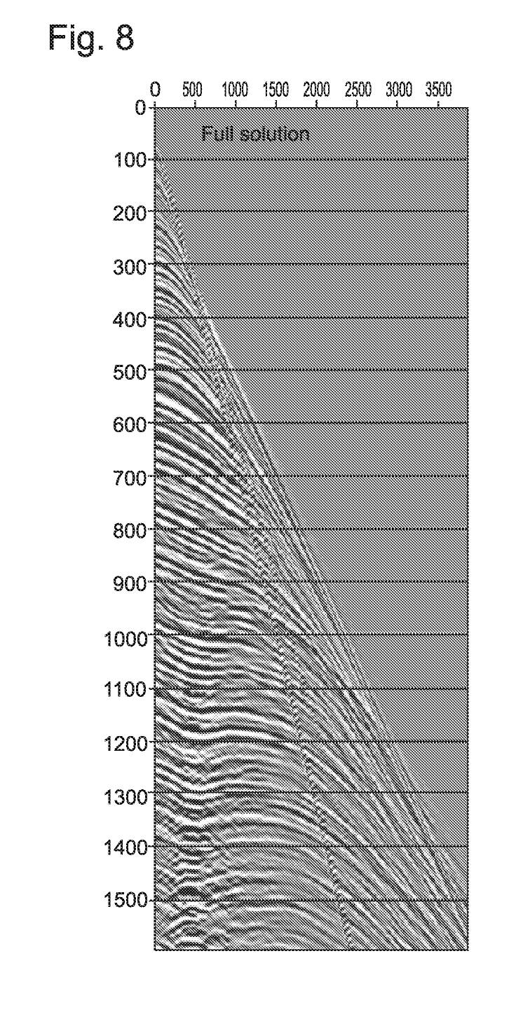

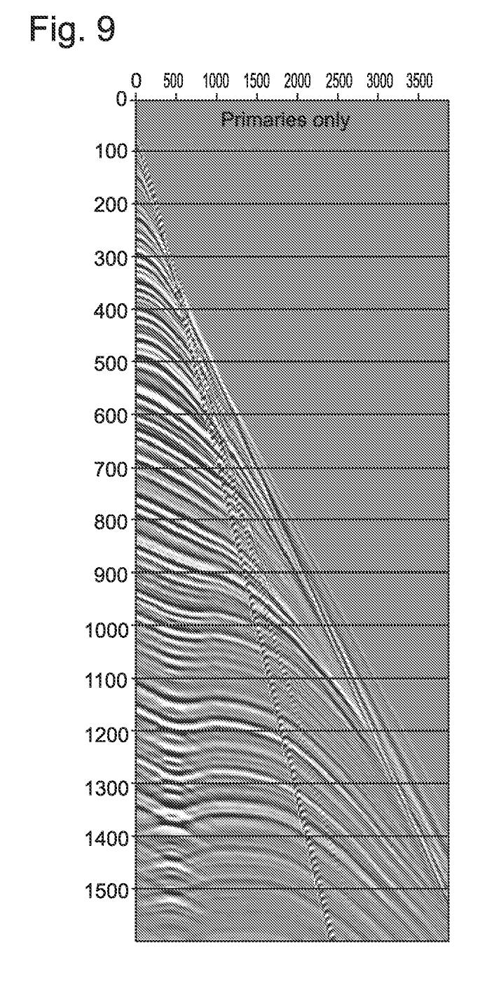

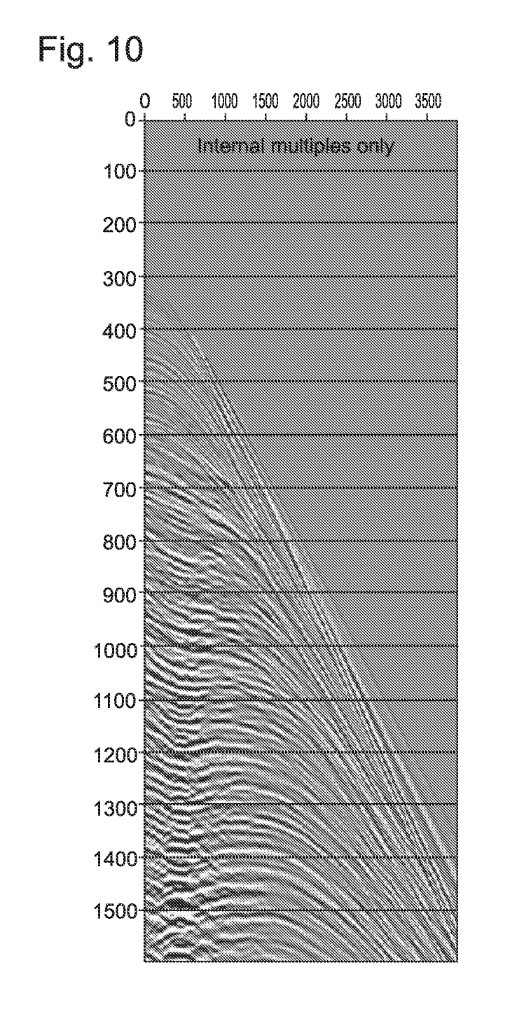

FIG. 8 (in which the axes and gray hues are used in the same manner as in FIGS. 5-7) illustrates the full two-way wave equation solution R(xs, ys, zs, xg, yg, zg, m). FIG. 9 illustrates in a similar manner the ensemble of primary reflections P(xs, ys, zs, xg, yg, zg, m), and FIG. 10 illustrates the ensemble of internal multiple reflections M(xs, ys, zs, xg, yg, zg, m).

Alternatively, internal multiple reflections M(xs, ys, zs, xg, yg, zg, m) may be calculated as:

M(xs,ys,zs,xg,yg,zg,m)=R(xs,ys,zs,xg,yg,zg,m)−P(xs,ys,zs,xg,yg,zg,m). (7)

The modeled primaries and internal multiples can be simultaneously subtracted from real data acquired on a targeted zone, the remainder revealing structural features not taken into consideration by the layer model (which features may otherwise be obscured by the strong signals due to the already considered impedance and/or velocity changes).

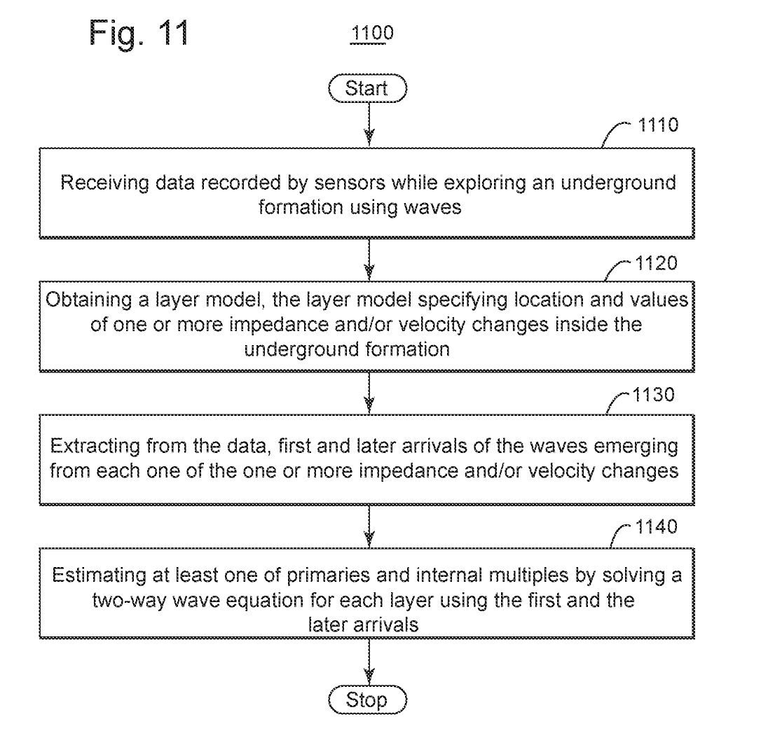

FIG. 11 is a flowchart illustrating operations of a method 1100 according to an embodiment. Method 1100 includes receiving data recorded by sensors while an underground formation is explored using waves at 1110. The waves may be seismic waves.

Method 1100 further includes obtaining a layer model, the layer model specifying one or more impedance and/or velocity changes inside the underground formation at 1120. The layer model may be obtained from log data (e.g., measurements of wave velocity and/or of density inside the underground formation). However, the layer model may also be obtained by inversion. The layer model may be two-dimensional or three-dimensional.

Method 1100 then includes extracting from the data first and later arrivals of waves emerging from each of the one or more impedance and/or velocity changes at 1130.

Method 1100 finally includes estimating at least one of primaries and internal multiples by solving a two-way wave equation using the first and later arrivals at 1140. The two-way wave equation for a depth ξ is set up and solved assuming that the wave propagates with a constant velocity below the depth ξ. A contribution, ΔP(ξ) to the primaries due to a layer from the depth ξ to a next depth ξ+Δξ may be calculated using formula (3).

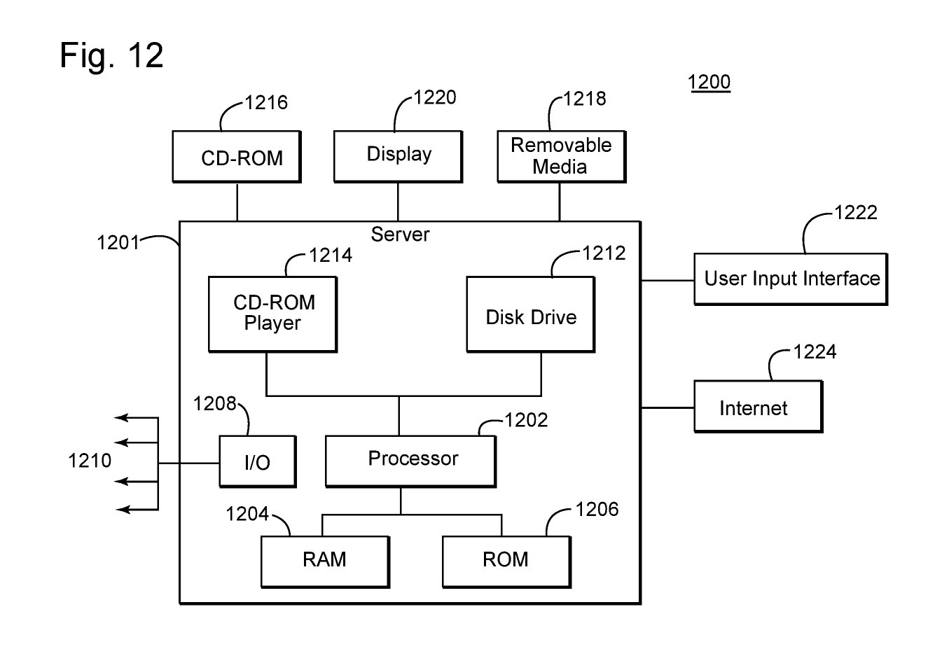

A schematic diagram of a seismic data processing apparatus 1200 configured to perform methods according to various above-discussed embodiments is illustrated in FIG. 12. Hardware, firmware, software or a combination thereof may be used to perform the various steps and operations. Apparatus 1200 may include server 1201 having a data processing unit (processor) 1202 coupled to a random access memory (RAM) 1204 and to a read-only memory (ROM) 1206. ROM 1206 may also be other types of storage media to store programs, such as programmable ROM (PROM), erasable PROM (EPROM), etc. Methods according to various embodiments described in this section may be implemented as computer programs (i.e., executable codes) non-transitorily stored on RAM 1204 or ROM 1206.

Processor 1202 may communicate with other internal and external components through input/output (I/O) circuitry 1208 and bussing 1210. Input-output (I/O) interface 1208 is configured to receive data recorded by sensors while exploring an underground formation using waves, and log data. The waves may be seismic and the log data may include measurements of wave velocity and of density inside the underground formation.

Processor 1202 carries out a variety of functions as are known in the art, as dictated by software and/or firmware instructions. Processor 1202 is configured to obtain a layer model from the log data, the layer model specifying one or more impedance changes inside the underground formation. Processor 1202 is further configured to extract from the data first and later arrivals of the waves emerging from each of the one or more impedance changes. Processor 1202 unit is also configured to estimate at least one of primaries and internal multiples by solving a two-way wave equation using the first and later arrivals. The data processing unit may set up and solve the two-way wave equation for a depth ξ, assuming that the wave propagates with a constant velocity below the depth ξ. The data processing unit may use formula (3) to calculate a contribution, ΔP(ξ), to the primaries due to a layer from the depth ξ to a next depth ξ+Δξ.

Server 1201 may also include one or more data storage devices, including disk drives 1212, CD-ROM drives 1214, and other hardware capable of reading and/or storing information, such as a DVD, etc. The input data and results of applying the methods may be stored in these data storage devices. In one embodiment, software for carrying out the above-discussed methods may be stored and distributed on a CD-ROM 1216, removable media 1218 or other forms of media capable of storing information. The storage media may be inserted into, and read by, devices such as the CD-ROM drive 1214, disk drive 1212, etc. Server 1201 may be coupled to a display 1220, which may be any type of known display or presentation screen, such as LCD, plasma displays, cathode ray tubes (CRT), etc. Server 1201 may control display 1220 to exhibit images of the explored subsurface structure generated using first and/or second seismic data. A user input interface 1222 may include one or more user interface mechanisms such as a mouse, keyboard, microphone, touchpad, touch screen, voice-recognition system, etc.

Server 1201 may be coupled to other computing devices, such as the equipment of a vessel, via a network. The server may be part of a larger network configuration as in a global area network such as the Internet 1224, which allows ultimate connection to various landline and/or mobile client/watcher devices.

The disclosed embodiments provide methods and apparatus for modeling and separating primaries and internal multiple reflections based on solutions of the two-wave equation. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in particular combinations, each feature or element may be usable alone without the other features and elements of the embodiments or in other various combinations with or without other features and elements disclosed herein.

The written description uses examples of the subject matter disclosed to enable any person skilled in the art to practice the same, including making and using the described devices or systems and performing any of the described methods. The patentable scope of the subject matter is defined by the claims, and may include other examples that occur to those skilled in the art. Such examples are intended to be within the scope of the claims.

1. A method, comprising:
receiving data recorded by sensors while an underground formation is explored using waves;
obtaining a layer model that specifies one or more impedance and/or velocity changes inside the underground formation, a layer of the model layer being defined between adjacent among the one or more impedance and/or velocity changes;
extracting from the data, first and later arrivals of the waves emerging from each of the one or more impedance and/or velocity changes; and
estimating at least one of primaries and internal multiples by solving a two-way wave equation for each layer of the model layer, using the first and the later arrivals, and summing portions of resulting solutions to obtain the primaries and/or to the internal multiples.

2. The method of claim 1, wherein the layer model is obtained from log data including measurements of wave velocity and/or of density inside the underground formation.

3. The method of claim 1, wherein the layer model is obtained by inversion.

4. The method of claim 1, wherein the layer model is a two-dimensional model.

5. The method of claim 1, wherein, a contribution, ΔP(ξ), to the primaries due to a layer from the depth ξ to a next depth ξ+Δξ is
ΔP(ξ)=ΔR(ξ)(1−H(t−(τ(xg,yg,zg,xm,ym,ξ)−T(ξ))))
where H is Heaviside function,
ΔR(ξ)=R(xs,ys,zs,xg,yg,zg,m(ξ))−R(xs,ys,zs,xg,yg,zg,m(ξ+Δξ)),
R(xs, ys, zs, xg, yg, zg, m (ξ)) and R(xs, ys, zs, xg, yg, zg, m (ξ+Δξ)) being full solutions of the two-way wave equation for the depth ξ and the next depth ξ+Δξ, respectively, with
m(ξ)=m(xm,ym,zm)(1−H(z−ξ))+H(z−ξ)m(xm,ym,ξ) and
m(ξ+Δξ)=m(xm,ym,zm)(1−H(z−H(z−ξ−Δξ))+H(z−ξ)m(xm,ym,ξ+Δξ),
for a wave source being located at xs, ys, zs, a sensor being located at xg, yg, zg, the layer model being m(xm, ym, zm), and m(xm, ym, ξ) and m(xm, ym, ξ+Δξ) representing the wave propagating with the constant velocity below depth ξ and ξ+Δξ, respectively, and τ(xg, yg, zg, xm, ym, ξ) being a two-way travel time from the sensor to the layer.

6. The method of claim 5, further comprising:
determining the two-way travel time analytically, or
determining the two-way travel time using a ray tracing method.

7. The method of claim 5, wherein the primaries are calculated by adding contributions of layers above a detection depth ξₘₐₓ:
P(xs,ys,zs,xg,yg,zg,m)=Σ_{ξ=ξmax}^{ξ=0}ΔP(ξ)Δξ.

8. The method of claim 7, further comprising:
subtracting the calculated primaries from the data, without using adaptive subtraction; and
generating an image of the underground formation using a result of the subtracting.

9. The method of claim 7, wherein the internal multiples, M, are calculated by subtracting the primaries, P, from a full solution of the two-way equation, R:
M(xs,ys,zs,xg,yg,zg,m)=R(xs,ys,zs,xg,yg,zg,m)−P(xs,ys,zs,xg,yg,zg,m).

10. The method of claim 9, further comprising:
subtracting the internal multiples from the data without using adaptive subtraction; and
generating an image of the underground formation using a result of the subtracting.

11. The method of claim 5,
wherein a contribution, ΔM(ξ), to the internal multiples due to the layer from ξ to ξ+Δξ is ΔM(ξ)=ΔR(ξ)−ΔP(ξ), and
the internal multiples, M, are calculated by adding contributions of all layers up to a detection depth ξₘₐₓ:
M(xs,ys,zs,xg,yg,zg,m)=Σ_{ξ=ξmax}^{ξ=0}ΔM(ξ)Δξ.

12. A data processing apparatus, the apparatus comprising:
an interface configured to receive log data and data recorded by sensors while an underground formation is explored using waves; and
a data processing unit configured
to obtain a layer model from the log data, the layer model specifying one or more impedance changes inside the underground formation, a layer of the model layer being defined between adjacent among the one or more impedance and/or velocity changes;
to extract from the data, first and later arrivals of the waves emerging from each of the one or more impedance changes; and
to estimate at least one of primaries and internal multiples by solving a two-way wave equation using the first and later arrivals, for each layer of the model layer, and then summing portions of resulting solutions to obtain the primaries and/or to the internal multiples.

13. The apparatus of claim 12, wherein the log data includes measurements of wave velocity and of density inside the underground formation.

14. The apparatus of claim 12, wherein the data processing unit solves the two-way wave equation to obtain a contribution, ΔP(ξ), to the primaries due to a layer from the depth ξ to a next depth ξ+Δξ as
ΔP(ξ)=ΔR(ξ)(1−H(t−(τ(xg,yg,zg,xm,ym,ξ)−T(ξ))))
where H is Heaviside function,
ΔR(ξ)=R(xs,ys,zs,xg,yg,zg,m(ξ))−R(xs,ys,zs,xg,yg,zg,m(ξ+Δξ)),
R(xs, ys, zs, xg, yg, zg, m (ξ)) and R(xs, ys, zs, xg, yg, zg, m (ξ+Δξ)) being full solutions of the two-way wave equation for the depth ξ and the next depth ξ+Δξ, respectively, with
m(ξ)m(xm,ym,zm)(1−H(z−ξ))+H(z−ξ)m(xm,ym,ξ) and
m(ξ+Δξ)=m(xm,ym,zm)(1−H(z−ξ−Δξ)+H(z−ξ)m(xm,ym,ξ+Δξ),
for a wave source being located at xs, ys, zs, a sensor being located at xg, yg, zg, the layer model being m(xm, ym, zm), and m(xm, ym, ξ) and m(xm, ym, ξ+Δξ) representing the wave propagating with the constant velocity below depth and respectively, and τ(xg, yg, zg, xm, ym, ξ) being a two-way travel time from the sensor to the layer.

15. The apparatus of claim 14, wherein the data processing unit further configured to determine the two-way travel time analytically, or using a ray tracing method.

16. The apparatus of claim 14, wherein the data processing unit is further configured
to calculate the primaries P(xs, ys, zs, xg, yg, zg, m) by adding contributions of layers above a detection depth ξₘₐₓ,
to subtract the calculated primaries from the data, without using adaptive subtraction, and
to generate an image of the underground formation using a result of the subtracting.

17. The apparatus of claim 14, wherein the data processing unit is further configured
to calculate the primaries P(xs, ys, zs, xg, yg, zg, m) by adding contributions of layers above a detection depth ξₘₐₓ, and
to calculate the internal multiples, M, by subtracting the primaries, P, from a full solution of the two-way equation, R:
M(xs,ys,zs,xg,yg,zg,m)=R(xs,ys,zs,xg,yg,zg,m)−P(xs,ys,zs,xg,yg,zg,m).

18. The apparatus of claim 14, wherein the data processing unit is further configured
to calculate a contribution, ΔM(ξ) to the internal multiples due to the layer from ξ to ξ+Δξ is ΔM(ξ)=ΔR(ξ)−ΔP(ξ) and the internal multiples, M, by adding contributions of all layers up to a detection depth ξₘₐₓ:
M(xs,ys,zs,xg,yg,zg,m)=Σ_{ξ=ξmax}^{ξ=0}ΔM(ξ)Δξ.

19. The apparatus of claim 18, wherein the data processing unit is further configured
to subtract the internal multiples from the data without using adaptive subtraction; and
to generate an image of the underground formation using a result of the subtracting.

20. A non-transitory computer readable medium storing executable codes, which, when executed by a computer make the computer perform a method for processing data recorded by sensors while an underground formation is explored using waves, the method comprising:
obtaining a layer model from log data, the layer model specifying one or more impedance changes inside the underground formation;
extracting from the data, first and later arrivals of the waves emerging from each of the one or more impedance changes; and
estimating at least one of primaries and internal multiples by solving a two-way wave equation using the first and later arrivals for each layer between adjacent among the one or more impedance and/or velocity changes, and summing contributions of each layer to the primaries and/or the internal multiples.
